(19) United States
(12) Patent Application Publication
(10) Pub. No.: US 2022/0245423 A1
(43) Pub. Date: Aug. 4, 2022

(54) ELECTRONIC DEVICE, USER TERMINAL, AND METHOD FOR RUNNING SCALABLE DEEP LEARNING NETWORK

(71) Applicant: Samsung Electronics Co., Ltd., Suwon-si (KR)

(72) Inventors: Sihyoung LEE, Suwon-si (KR); Daehee KIM, Suwon-si (KR); Kyungjae LEE, Suwon-si (KR); Taehwa HONG, Suwon-si (KR)

(21) Appl. No.: 17/723,922

(22) Filed: Apr. 19, 2022

Related U.S. Application Data
(63) Continuation of application No. PCT/KR2020/011190, filed on Aug. 21, 2020.

(30) Foreign Application Priority Data
Oct. 22, 2019 (KR) 10-2019-0131227

(51) Int. Cl. G06N 3/04; G06N 3/08

(52) U.S. Cl. CPC G06N 3/04; G06N 3/082

(57) ABSTRACT

An electronic device is provided. The electronic device includes a communication circuit, a processor, and a memory operatively connected to the processor, wherein the memory may store instructions configured to, when executed, cause the processor to determine scalability of a deep learning network including a plurality of layers, divide the deep learning network into a plurality of blocks on the basis of the scalability, receive, from a user terminal, information about the processing capability of the user terminal, select at least one of the plurality of blocks on the basis of the received information, and transmit the at least one selected block to the user terminal.

### CROSS-REFERENCE TO RELATED APPLICATION(S)

This application is a continuation application, claiming priority under § 365(c), of an International application No. PCT/KR2020/011190, filed on Aug. 21, 2020, which is based on and claims the benefit of a Korean patent application number 10-2019-0131227, filed on Oct. 22, 2019, in the Korean Intellectual Property Office, the disclosure of which is incorporated by reference herein in its entirety.

### BACKGROUND

### 1. Field

The disclosure relates to an electronic device, a user terminal, and a method for driving a scalable deep learning network.

### 2. Description of Related Art

Artificial intelligence (AI) technology implements human-level intelligence through a computer system and is capable of learning by itself through a deep learning network. The deep learning network is an algorithm that classifies or learns the characteristics of input data by itself

As the deep learning technology develops, a machine may learn repeatedly until it derives a target result value by analyzing data (e.g., image, voice) by itself.

The above information is presented as background information only to assist with an understanding of the disclosure. No determination has been made, and no assertion is made, as to whether any of the above might be applicable as prior art with regard to the disclosure.

### SUMMARY

The deep learning network performs iterative learning to determine a parameter that may derive a desired result value. Because a process of performing the iterative learning requires many operations, a high level of operation processing capability may be required.

In case of a device (e.g., a mobile terminal) having relatively limited operation processing capability, it may take a lot of time to analyze data by using the deep learning network.

In case of a method of using a simple approximation of the operation of layers included in the deep learning network or method of reducing the size of data input to the deep learning network in order to shorten the data analysis time through the deep learning network of the device having relatively limited operation processing capability, it may need to separately train suitable deep learning networks depending on the operation processing capability of various devices.

Additional aspects will be set forth in part in the description which follows and, in part, will be apparent from the description, or may be learned by practice of the presented embodiments.

In accordance with an aspect of the disclosure, an electronic device is provided. The electronic device includes a communication circuit, a processor, and a memory operatively connected to the processor. The memory according to various embodiments may store instructions that cause, when executed, the processor to determine scalability of a deep learning network including a plurality of layers, to divide the deep learning network into a plurality of blocks, based on the scalability, to receive information about processing capability of a user terminal from the user terminal, to select at least one of the plurality of blocks, based on the received information, and to transmit the selected at least one block to the user terminal.

In accordance with another aspect of the disclosure, a user terminal is provided. The user terminal includes a communication circuit, a processor, and a memory operatively connected to the processor. The memory according to various embodiments may store instructions that cause, when executed, the processor to transmit information about processing capability of the user terminal to an external electronic device, to receive at least one block including at least one of a plurality of layers of a deep learning network from the external electronic device, and to reconstruct a deep learning network by using the at least one block.

In accordance with another aspect of the disclosure, a method for driving a deep learning network in an electronic device is provided. The method includes determining scalability of a deep learning network including a plurality of layers, dividing the deep learning network into a plurality of blocks, based on the scalability, receiving information about processing capability of a user terminal from the user terminal, selecting at least one of the plurality of blocks, based on the received information, and transmitting the selected at least one block to the user terminal.

An electronic device according to various embodiments of the disclosure divides a deep learning network including a plurality of layers into a plurality of blocks, selects at least one block from among the plurality of blocks based on the processing capability of a user terminal, and provides it to the user terminal, so that the user terminal may construct and use a deep learning network suitable for processing capability.

According to various embodiments of the disclosure, because the user terminal performs deep learning analysis by using the reconstructed deep learning network, it is possible to realize a faster processing speed than in a method of performing the deep learning analysis through a server, reduce the amount of data transmission/reception, and reduce power consumption of the user terminal.

According to various embodiments of the disclosure, a user terminal having a relatively low operation processing capability may perform a simple and fast deep learning analysis by receiving only some blocks of the deep learning network from the electronic device. The user terminal may efficiently manage a memory by storing only information corresponding to some blocks of the deep learning network.

According to various embodiments of the disclosure, a user terminal having a relatively high operation processing capability may perform a detailed deep learning analysis capable of obtaining an output value of high performance by receiving all of a plurality of blocks of the deep learning network.

According to various embodiments of the disclosure, the user terminal may efficiently update the used deep learning network by newly receiving only some of at least one block received from the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of an electronic device according to an embodiment of the disclosure;

FIG. 3 is a block diagram of a user terminal according to an embodiment of the disclosure;

FIG. 4 is a diagram schematically illustrating a scalable deep learning network according to an embodiment of the disclosure;

FIG. 5 is a diagram illustrating a method for dividing a deep learning network into a plurality of blocks according to an embodiment of the disclosure;

FIGS. 6A and 6B are diagrams illustrating a method for reconstructing a deep learning network using a block received from a user terminal according to various embodiments of the disclosure;

FIG. 7 is a flow diagram illustrating operations of an electronic device according to an embodiment of the disclosure;

FIG. 8 is a flow diagram illustrating operations of an electronic device according to an embodiment of the disclosure;

FIG. 9 is a diagram schematically illustrating a scalable deep learning network according to an embodiment of the disclosure;

FIG. 10 is a diagram illustrating a method for updating a deep learning network in a user terminal according to an embodiment of the disclosure; and

FIG. 11 is a flow diagram illustrating operations of a user terminal according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

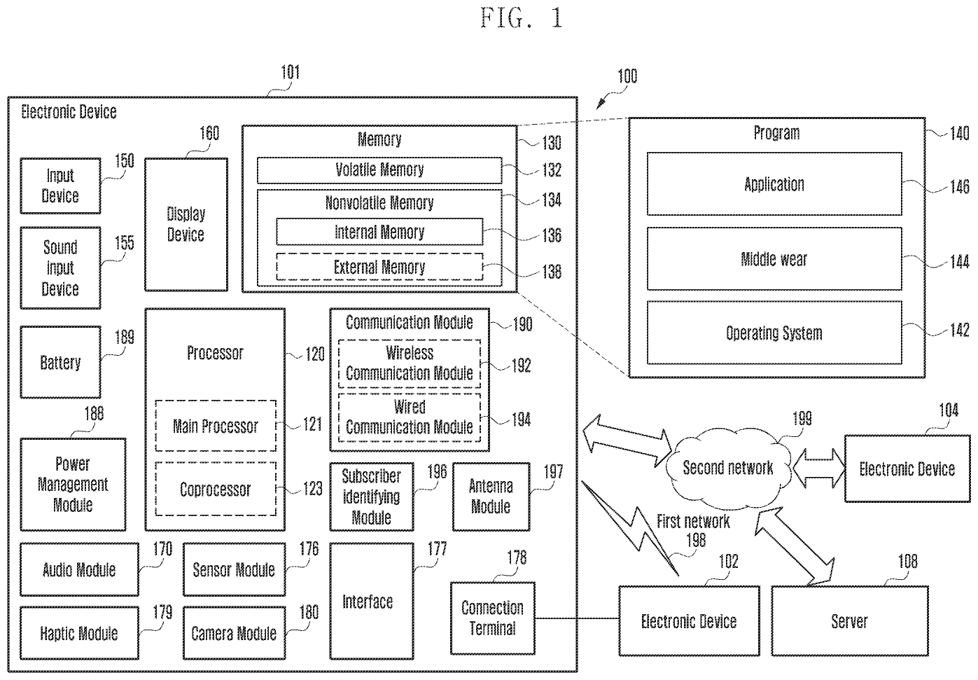

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., printed circuit board (PCB)). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

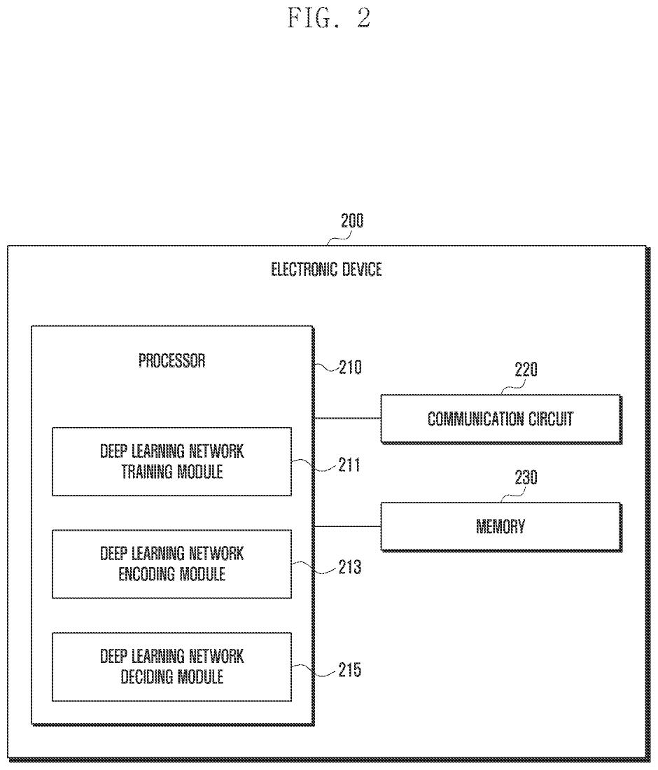

FIG. 2 is a block diagram of an electronic device according to an embodiment of the disclosure. Specifically, FIG. 2 is a hardware and software block diagram of the electronic device according to various embodiments of the disclosure.

Referring to FIG. 2, the electronic device 200 according to various embodiments may be, for example, a server.

The electronic device 200 according to various embodiments may include a processor 210 (e.g., the processor 120 in FIG. 1), a communication circuit 220 (e.g., the communication module 190 in FIG. 1), or a memory 230 (e.g., the memory 130 in FIG. 1). Even if some of components shown in FIG. 2 are omitted or substituted, there may be no hindrance to implementing various embodiments disclosed herein.

According to various embodiments, the processor 210 of the electronic device 200 may be constituted to perform operations or data processing related to control and/or communication of each component of the electronic device 200. For example, the processor 210 may be operatively connected to components of the electronic device 200. The processor 210 may load a command or data received from any other component of the electronic device 200 on the memory 230, process the command or data stored in the memory 230, and store the result data.

According to various embodiments, the memory 230 of the electronic device 200 may store instructions for the operations of the processor 210 described above. According to various embodiments, the memory 230 of the electronic device 200 may store a deep learning network. For example, the memory 230 of the electronic device 200 may store a scalable deep learning network.

According to various embodiments, deep learning is one field of artificial intelligence and may include various machine learning methods capable of realizing functions such as human learning ability in a computing device. The deep learning network may be a network based on an artificial neural network. The deep learning network may be an artificial neural network composed of, for example, an input layer, a hidden layer, and an output layer. The hidden layer may consist of one or more layers. The input layer may refer to a layer in which data is initially set, the hidden layer may refer to a layer in which data is not revealed and hidden, and the output layer may refer to a layer in which learned data to be obtained resultantly is outputted. The deep learning network may have a structure in which a plurality of layers performing specific operations are stacked. In various embodiments of the disclosure, a layer may refer to the hidden layer of the artificial neural network.

The deep learning network may include, for example, at least one of a deep neural network (DNN), a convolutional neural network (CNN), a recurrent neural network (RNN), an auto encoder, a generative adversarial network (GAN), or a deep belief network (DBN). Of course, various embodiments of the disclosure may be applied to various deep learning networks including a plurality of layers in addition to the deep learning network.

The scalable deep learning network may refer to, for example, an expandable (or contractible) deep learning network structure. For example, the scalable deep learning network may be a learning algorithm capable of processing large amounts of data even without consuming large amounts of resources.

The scalable deep learning network may have a plurality of scalable structures. For example, through the scalable deep learning network having a plurality of scalable structures, a plurality of output values may be obtained.

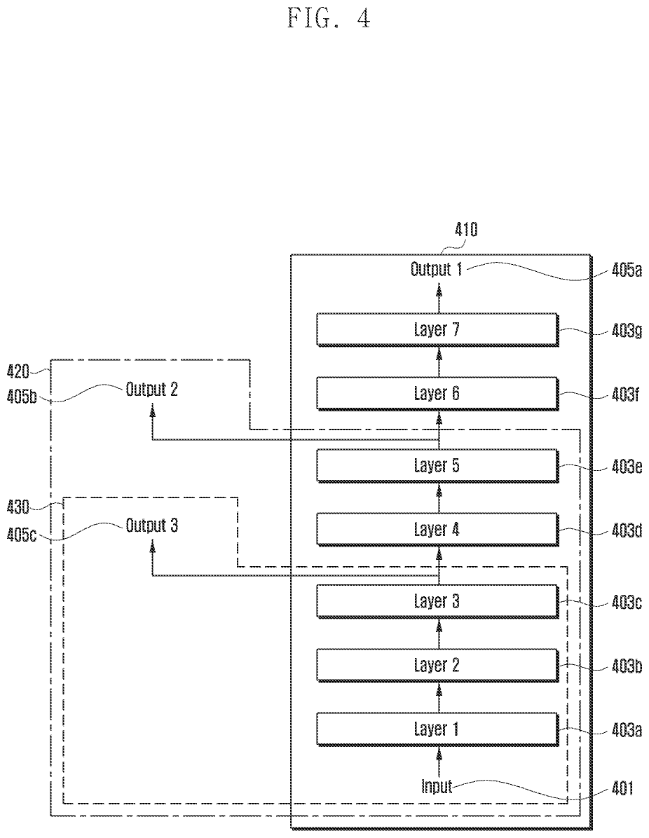

The scalability of the scalable deep learning network may refer to the number of scalable structures of the scalable deep learning network. For example, the scalability of the scalable deep learning network may refer to the number of result values outputted through the scalable deep learning network. The deep learning network described in various embodiments of the disclosure may refer to the scalable deep learning network. A detailed description of the scalability of the deep learning network will be described below with reference to FIG. 4.

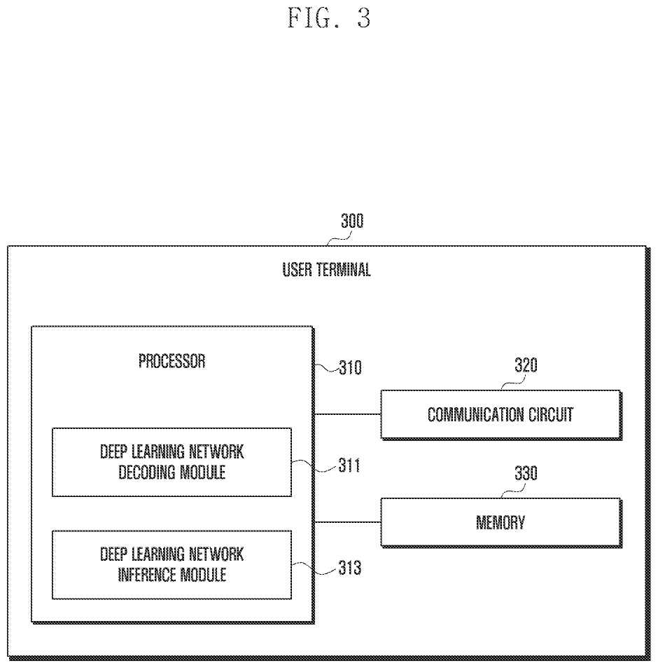

According to various embodiments, the communication circuit 220 of the electronic device 200 may establish a communication channel with an external device (e.g., the user terminal 300 in FIG. 3) and transmit/receive various data to/from the external device. According to various embodiments, the communication circuit 220 may include a cellular communication module to be connected to a cellular network (e.g., 3rd generation (3G), LTE, 5th generation (5G), Wibro, or Wimax). According to various embodiments, the communication circuit 220 may include a short-range communication module to transmit/receive data to/from an external device through short-range communication (e.g., Wi-Fi, Bluetooth, Bluetooth Low Energy (BLE), or UWB). However, this is not a limitation.

According to various embodiments, the processor 210 of the electronic device 200 may include a deep learning network training module 211, a deep learning network encoding module 213, or a deep learning network deciding module 215.

The deep learning network training module 211 according to various embodiments may be a module for training the deep learning network until it achieves a target performance. According to various embodiments, the deep learning network training module 211 may train the deep learning network until the target performance is achieved, and may determine the scalability of the deep learning network, based on the number of result values that may be obtained in the training process. For example, the processor 210 of the electronic device 200 may repeatedly train the deep learning network to output a plurality of result values. The deep learning network training module 211 may determine the target performance as one value or a plurality of different values in consideration of the performance of a plurality of result values outputted from the deep learning network.

The deep learning network encoding module 213 according to various embodiments may be a module for dividing the trained deep learning network into a plurality of block units. For example, based on the scalability of the deep learning network, the deep learning network encoding module 213 may divide the deep learning network into a plurality of blocks. For example, when the scalability of the deep learning network is 3, the deep learning network encoding module 213 may divide the deep learning network into three blocks.

The deep learning network may include a plurality of layers. Each of the plurality of layers of the deep learning network may be a layer that performs a specific operation. The deep learning network encoding module 213 may divide the deep learning network into a plurality of blocks so that at least one layer may form one block. For example, each of the plurality of blocks may contain information about the deep learning network structure for each of the plurality of blocks, a parameter corresponding to at least one layer included in each of the plurality of blocks, and connection information between the at least one layer included in each of the plurality of blocks.

The deep learning network encoding module 213 according to various embodiments may add a new layer to a specific block among a plurality of blocks. The added new layer may be a new layer that is not included in the plurality of layers.

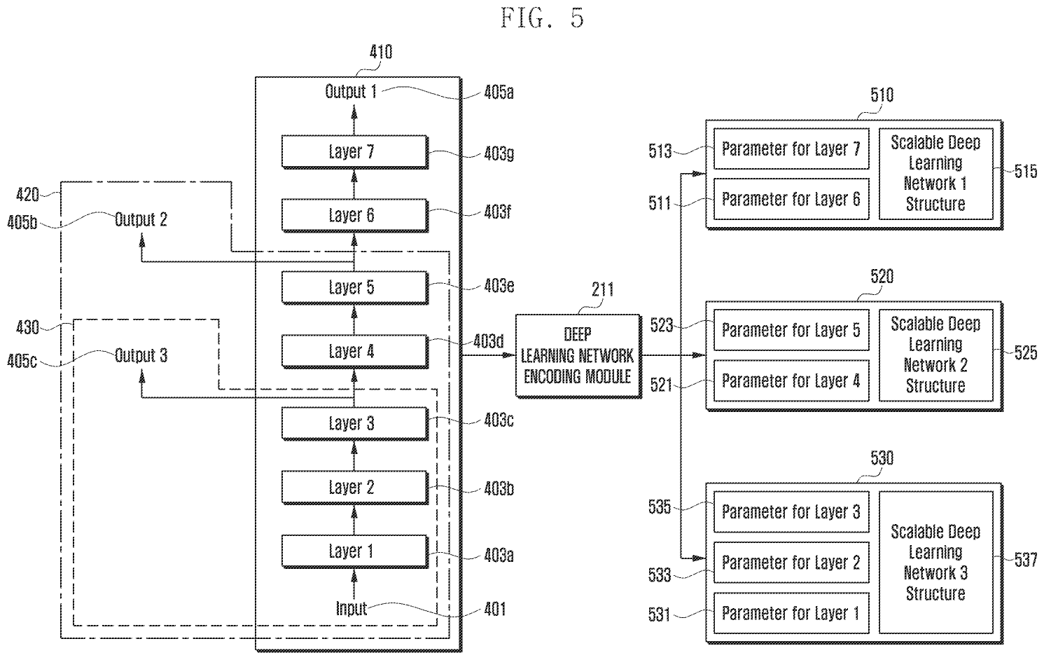

The operation of dividing the deep learning network into a plurality of blocks will be described later in detail with reference to FIG. 5.

The deep learning network deciding module 215 according to various embodiments may decide a deep learning network structure most suitable for the user terminal 300, based on information about the processing capability of the user terminal 300 to be provided with a deep learning service. For example, the deep learning network deciding module 215 may decide a deep learning network structure suitable for the user terminal 300 from among a plurality of scalable structures of the deep learning network. The information about the processing capability of the user terminal 300 may include, for example, at least one of operation processing capability and communication network speed. The operation processing capability of the user terminal 300 may include, for example, the operation processing capability of CPU, GPU, or micro processing unit (MPU).

The deep learning network deciding module 215 according to various embodiments may select at least one block corresponding to the decided deep learning network structure. The deep learning network deciding module 215 may transmit the at least one selected block to the user terminal (e.g., the user terminal 300 in FIG. 3) through the communication circuit 220.

FIG. 3 is a block diagram of a user terminal according to an embodiment of the disclosure. Specifically, FIG. 3 is a hardware and software block diagram of the user terminal according to various embodiments of the disclosure.

Referring to FIG. 3, the user terminal 300 according to various embodiments may receive blocks related to the deep learning network from the electronic device 200, thereby reconstructing the deep learning network and performing the deep learning analysis of input data through the reconstructed deep learning network.

The user terminal 300 according to various embodiments may include a processor 310 (e.g., the processor 120 in FIG. 1), a communication circuit 320 (e.g., the communication module 190 in FIG. 1), or a memory 330 (e.g., the memory 130 in FIG. 1). Even if some of components shown in FIG. 3 are omitted or substituted, there may be no hindrance to implementing various embodiments disclosed herein.

According to various embodiments, the processor 310 of the user terminal 300 may be configured to perform operations or data processing related to control and/or communication of each component of the user terminal 300. For example, the processor 310 may be operatively connected to components of the user terminal 300. The processor 310 may load a command or data received from any other component of the user terminal 300 on the memory 330 of the user terminal 300, process the command or data stored in the memory 330 of the user terminal 300, and store the result data.

According to various embodiments, the communication circuit 320 of the user terminal 300 may establish a communication channel with an external device (e.g., the electronic device 200 in FIG. 2) and transmit/receive various data to/from the external device. According to various embodiments, the communication circuit 320 of the user terminal 300 may include a cellular communication module to be connected to a cellular network (e.g., 3G, LTE, 5G, Wibro, or Wimax). According to various embodiments, the communication circuit 320 of the user terminal 300 may include a short-range communication module to transmit/receive data to/from an external device through short-range communication (e.g., Wi-Fi, Bluetooth, Bluetooth Low Energy (BLE), or UWB). However, this is not a limitation.

According to various embodiments, the memory 330 of the user terminal 300 may store instructions for the operations of the processor 310 of the user terminal 300 described above.

The processor 310 of the user terminal 300 according to various embodiments may transmit information about the processing capability of the user terminal 300 to the electronic device 200 through the communication circuit 320. The information about the processing capability of the user terminal 300 may include, for example, at least one of operation processing capability and communication network speed. The operation processing capability of the user terminal 300 may include, for example, the operation processing capability of CPU, GPU, or MPU.

The processor 310 of the user terminal 300 according to various embodiments may receive at least one block from the electronic device 200 through the communication circuit 320.

The processor 310 of the user terminal 300 according to various embodiments may include a deep learning network decoding module 311 or a deep learning network inference module 313.

The deep learning network decoding module 311 according to various embodiments may reconstruct the deep learning network by using at least one block received from the electronic device 200. The at least one block may contain information about the deep learning network structure for each of the at least one block, a parameter corresponding to at least one layer included in each of the at least one block, and connection information between the at least one layer included in each of the at least one block.

The deep learning network decoding module 311 may determine (or defined) a relationship between at least one layer included in at least one block by using, for example, information about the deep learning network structure contained in at least one block. The deep learning network decoding module 311 may allocate, for example, a parameter corresponding to at least one layer. The deep learning network decoding module 311 may reconstruct the deep learning network, for example, based on connection information between the at least one layer.

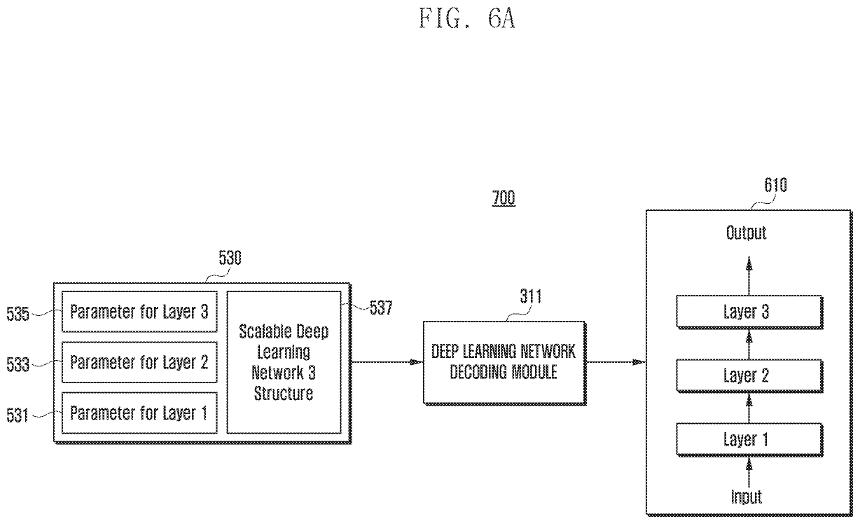

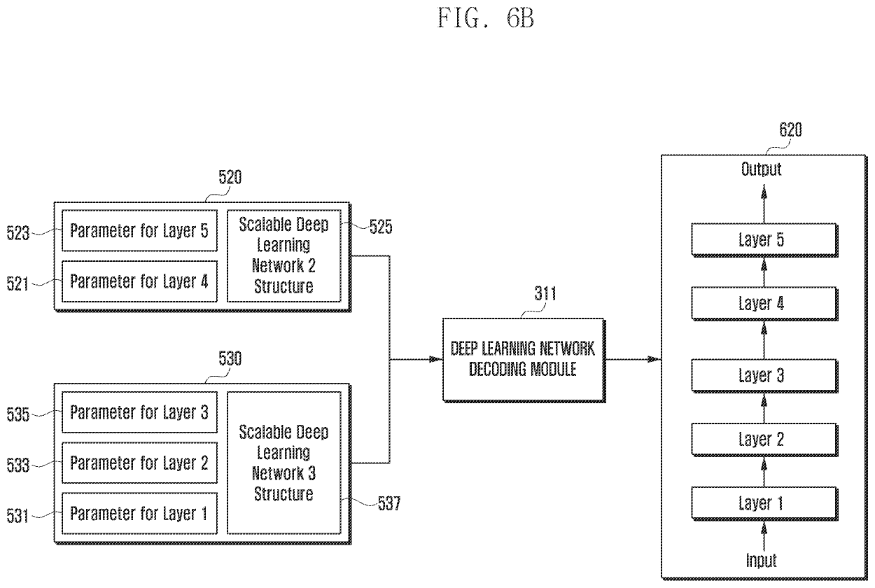

A method for reconstructing the deep learning network using at least one block received from the user terminal 300 will be described later in detail with reference to FIGS. 6A and 6B.

The deep learning network inference module 313 according to various embodiments may analyze data by using the reconstructed deep learning network.

Although it has been described in FIGS. 2 and 3 that the deep learning network decoding module 311 is included in the user terminal 300, the deep learning network decoding module 311 according to various embodiments may be included in the electronic device 200. In case that the deep learning network decoding module 311 is included in the electronic device 200, the processor 310 of the electronic device 200 may select at least one block most suitable for the user terminal 300 and reconstruct the deep learning network using the selected at least one block. The processor 310 of the electronic device 200 may transmit the reconstructed deep learning network to the user terminal 300. The processor 310 of the user terminal 300 may receive the reconstructed deep learning network and analyze data by using the reconstructed deep learning network.

FIG. 4 is a diagram schematically illustrating a scalable deep learning network according to an embodiment of the disclosure.

Referring to FIG. 4, the deep learning network according to various embodiments may include a plurality of layers. For example, the deep learning network may include an input layer 401, output layers 405a, 405b, and 405c, and a plurality of hidden layers 403a to 403g. The input layer may refer to a layer in which data is initially set, the hidden layer may refer to a layer in which data is not revealed and hidden, and the output layer may refer to a layer in which learned data to be obtained resultantly is outputted. FIG. 4 schematically shows the deep learning network including seven hidden layers 403a to 403g. The number of hidden layers may be variously implemented.

According to various embodiments, each of the plurality of hidden layers 403a to 403g may be a layer that performs a specific operation. Each layer may generate an output value by performing a specific operation on an input value and transmit it to the next layer. For example, a first layer 403a may receive input data from the input layer 401, perform an operation allocated to the first layer 403a on the received input data, and transmit an output value to a second layer 403b. The deep learning network may repeat such a process as many as the number of layers and thereby learn nonlinear relationships. Because the respective layers may learn different level features, it is possible to understand a potential structure of input data through the deep learning network. If weights included in the deep learning network are appropriately adjusted, it is possible to output a learned result value desired by the user. Each layer may include a plurality of nodes, and data operation may be performed at each node. In FIG. 4, the deep learning network is simply illustrated in units of layers.

The deep learning network according to various embodiments may have a plurality of scalable structures 410 (solid line), 420 (alternated long and short dash line), and 430 (dotted line). FIG. 4 shows the deep learning network having three scalable structures. The number of scalable structures of the deep learning network may be defined as scalability. The deep learning network with scalability of 3 may be trained to output three output values.

For example, the deep learning network may obtain a first output value (output 1) 405a by going through all layers from the first layer 403a to the seventh layer 403g. In addition, the deep learning network may also obtain a second output value (output 2) 405b by going through layers from the first layer 403a only up to the fifth layer 403e. In addition, the deep learning network may also obtain a third output value (output 3) 405c by going through layers from the first layer 403a only up to the third layer 403c. The first output value 405a, the second output value 405b, and the third output value 405c may be, for example, result values having different performances. For example, the first output value 405a obtained by performing the most operations may be data having the highest performance, and the third output value 405c obtained by performing the fewest operations may be data having the lowest performance. The performance of the output value may refer to, for example, the accuracy of deep learning analysis.

For example, suppose that the deep learning network provides a service for classifying objects contained in an image. In the above-described case, the first output value 405a may be a value obtained by classifying up to detailed categories of objects contained in an image by using a sufficient operation. The third output value 405c may be a value obtained by quickly classifying only rough categories of objects contained in an image by using a simple operation. For example, the third output value 405c may be a value indicating that the object contained in the image is a bird, and the first output value 405a may be a value indicating that the object contained in the image is an eagle among birds.

The first deep learning network structure 410 may obtain the first output value 405a of high performance through a large amount of operations, so that it may be suitable to be performed in the user terminal 300 having high processing capability.

The third deep learning network structure 430 may quickly obtain the third output value 405c of low performance through a small amount of operations, so that it may be suitable to be performed in the user terminal 300 having low processing capability.

The processor 210 of the electronic device 200 according to various embodiments may determine a deep learning network structure most suitable to be performed in the user terminal 300, based on information about the processing capability of the user terminal 300. For example, based on whether an operation processing speed of the MPU of the user terminal 300 exceeds a predetermined threshold, it is possible to determine a deep learning network structure suitable for the user terminal 300. The predetermined threshold may be configured as a plurality of values to correspond to the scalability of the deep learning network.

FIG. 5 is a diagram illustrating a method for dividing a deep learning network into a plurality of blocks according to an embodiment of the disclosure.

Referring to FIG. 5, the processor 210 of the electronic device 200 according to various embodiments may determine the scalability of the deep learning network including a plurality of layers. Based on the determined scalability, the processor 210 of the electronic device 200 according to various embodiments may divide the deep learning network into a plurality of blocks. FIG. 5 schematically shows a deep learning network in which scalability is defined as 3.

In the processor 210 of the electronic device 200 according to various embodiments, the deep learning network encoding module 213 may divide the trained deep learning network with scalability defined as 3 into three blocks. The deep learning network encoding module 213 according to various embodiments may divide the deep learning network into a plurality of blocks by disallowing a layer overlap between blocks. According to various embodiments, the deep learning network encoding module 213 may also divide the deep learning network into a plurality of blocks by allowing a layer overlap between each block.

For example, the deep learning network encoding module 213 may divide the deep learning network into a first block 510 including a sixth layer 403f and a seventh layer 403g, a second block 520 including a fourth layer 403d and a fifth layer 403e, and a third block 530 including a first layer 403a, a second layer 403b, and a third layer 403c.

According to various embodiments, the plurality of blocks 510, 520, and 530 may contain information about a deep learning network structure for each of the plurality of blocks 510, 520, and 530, a parameter corresponding to at least one layer included in each of the plurality of blocks 510, 520, and 530, and connection information between at least one layer included in each of the plurality of blocks.

For example, the third block 530 may contain information 537 about a third deep learning network structure corresponding to the third block 530. For example, the third block 530 may contain a parameter 531 corresponding to the first layer, a parameter 533 corresponding to the second layer, and a parameter 535 corresponding to the third layer. For example, the third block 530 may contain connection information between the first layer 403a and the second layer 403b and connection information between the second layer 403b and the third layer 403c. For example, the third block 530 may further contain connection information between the third layer 403c and the fourth layer 403d in consideration of a case in which the third block 530 and the second block 520 are combined.

For example, the second block 520 may contain information 525 about a second deep learning network structure corresponding to the second block 520. For example, the second block 520 may contain a parameter 521 corresponding to the fourth layer and a parameter 523 corresponding to the fifth layer. For example, the second block 520 may contain connection information between the fourth layer 403d and the fifth layer 403e. For example, the second block 520 may further contain connection information between the third layer 403c and the fourth layer 403d in consideration of a case of being combined with the third block 530. For example, the second block 520 may further contain connection information between the fifth layer 403e and the sixth layer 403f in consideration of a case of being combined with the first block 510.

For example, the first block 510 may contain information 515 about a first deep learning network structure corresponding to the first block 510. For example, the first block 510 may contain a parameter 511 corresponding to the sixth layer and a parameter 513 corresponding to the seventh layer. For example, the first block 510 may contain connection information between the sixth layer 403f and the seventh layer 403g.

FIG. 5 schematically shows a method for dividing a deep learning network by disallowing a layer overlap between blocks. Although not shown, in case of dividing a deep learning network by allowing a layer overlap between blocks, the processor 210 of the electronic device 200 may define, for example, the first block as including the first to seventh layers, the second block as including the first to fifth layers, and the third block as including the first to third layers.

The processor 210 of the electronic device 200 according to various embodiments may determine a block to be transmitted to the user terminal 300, based on information about the processing capability of the user terminal 300.

For example, when the processing capability of the user terminal 300 is relatively low, the processor 210 of the electronic device 200 may determine a deep learning network structure suitable for the user terminal 300 to be the third deep learning network structure 430 that outputs the third result value 405c. The processor 210 of the electronic device 200 may select the third block 530 corresponding to the third deep learning network structure 430. The processor 210 of the electronic device 200 may transmit the selected third block 530 to the user terminal 300. For example, based on whether the operation processing speed of the MPU of the user terminal 300 exceeds a predetermined threshold, it may be determined whether the processing capability of the user terminal 300 is relatively high or low.

For example, when the processing capability of the user terminal 300 is relatively high, the processor 210 of the electronic device 200 may determine a deep learning network structure suitable for the user terminal 300 to be the first deep learning network structure 410 that outputs the first result value 405a. The processor 210 of the electronic device 200 may select all of the first block 510, the second block 520, and the third block 530 corresponding to the first deep learning network structure 410. The processor 210 of the electronic device 200 may transmit all of the selected first, second, and third blocks 510, 520, and 530 to the user terminal 300.

FIGS. 6A and 6B are diagrams illustrating a method for reconstructing a deep learning network using a block received from a user terminal 300 according to various embodiments of the disclosure.

Referring to FIG. 6A, the user terminal 300 according to various embodiments may receive at least one block from the electronic device 200. For example, suppose that the user terminal 300 has received the third block 530 from the electronic device 200.

In the processor 310 of the user terminal 300 according to various embodiments, the deep learning network decoding module 311 may reconstruct the deep learning network by using the third block 530. The deep learning network decoding module 311 in the processor 310 of the user terminal 300 may reconstruct the deep learning network by using information contained in the third block 530. For example, the deep learning network decoding module 311 may identify the information 537 about the deep learning network structure included in the third block 530. Because the information 537 about the deep learning network structure contained in the third block relates to the third deep learning network structure 430, the deep learning network decoding module 311 may reconstruct the deep learning network having the third deep learning network structure 430 by using the first layer 403a, the second layer 403b, and the third layer 403c.

The deep learning network decoding module 311 according to various embodiments may determine relationships among the first layer 403a, the second layer 403b, and the third layer 403c, based on the information 537 about the deep learning network structure contained in the third block 530. For example, the deep learning network decoding module 311 may determine that the structure of the deep learning network to be reconstructed should be configured in the order of ‘input layer’, ‘first layer’, ‘second layer’, ‘third layer’, and ‘output layer’.

The deep learning network decoding module 311 according to various embodiments may allocate corresponding parameters to the first layer, the second layer, and the third layer, respectively, based on the parameters 531, 533, and 535 corresponding to the respective layers contained in the third block 530.

The deep learning network decoding module 311 according to various embodiments may reconstruct the deep learning network, based on the connection information between the first and second layers contained in the third block 530.

A deep learning network 610 reconstructed by the deep learning network decoding module 311 according to various embodiments using the third block 530 may have the third deep learning network structure 430.

The user terminal 300 according to various embodiments may analyze data by using the reconstructed deep learning network 610.

Referring to FIG. 6B, the user terminal 300 according to various embodiments may receive the second block 520 and the third block 530 from the electronic device 200.

In the processor 310 of the user terminal 300 according to various embodiments, the deep learning network decoding module 311 may identify information about a deep learning network structure contained in an upper block and determine a relationship between layers. The upper block may refer to, for example, a block to which a lower number is allocated. For example, the deep learning network decoding module 311 may determine relationships among layers included in the second block 520 and the third block 530, based on the information 525 about the deep learning network structure contained in the second block 520. For example, because the information 525 about the deep learning network structure contained in the second block 520 is the second deep learning network structure, the deep learning network decoding module 311 may determine that the structure of the deep learning network to be reconstructed should be configured in the order of ‘input layer’, ‘first layer’, ‘second layer’, ‘third layer’, ‘fourth layer’, ‘fifth layer’, and ‘output layer’.

The deep learning network decoding module 311 according to various embodiments may allocate corresponding parameters to the first layer, the second layer, the third layer, the fourth layer, and the fifth layer, respectively, based on the parameters 531, 533, 535, 521, and 523 corresponding to the respective layers contained in the second and third blocks 520 and 530.

The deep learning network decoding module 311 according to various embodiments may reconstruct the deep learning network, based on the connection information among the first to fifth layers contained in the second and third blocks 520 and 530.

A deep learning network 620 reconstructed by the deep learning network decoding module 311 according to various embodiments using the second and third blocks 520 and 530 may have the second deep learning network structure 420.

The user terminal 300 according to various embodiments may analyze data by using the reconstructed deep learning network 620.

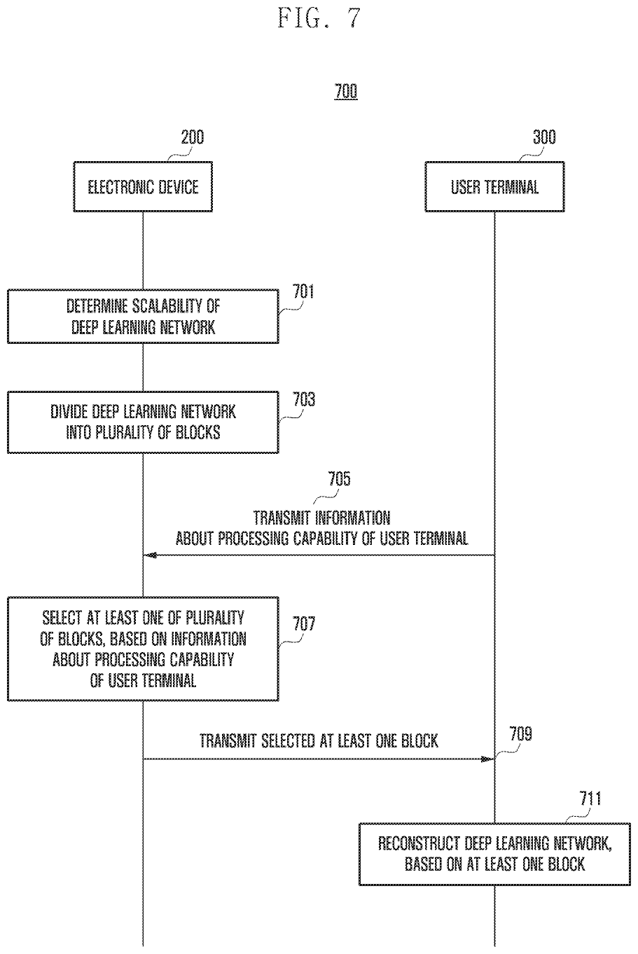

FIG. 7 is a flow diagram illustrating operations of an electronic device 200 according to an embodiment of the disclosure.

Referring to FIG. 7, the flow diagram 700 of operations, the electronic device 200 according to various embodiments may determine the scalability of a deep learning network at operation 701. For example, based on the number of scalable structures of the deep learning network including a plurality of layers, the electronic device 200 may determine the scalability of the deep learning network.

At operation 703, the electronic device 200 according to various embodiments may divide the deep learning network into a plurality of blocks, based on the scalability.

At operation 705, the user terminal 300 according to various embodiments may transmit information about the processing capability of the user terminal 300 to the electronic device 200. The information about the processing capability of the user terminal 300 may include, for example, at least one of information about the operation processing capability of the user terminal 300 and a communication network speed.

At operation 707, the electronic device 200 according to various embodiments may select at least one of the plurality of blocks, based on the information about the processing capability of the user terminal 300. For example, based on the information about the processing capability of the user terminal 300, the electronic device 200 may decide a deep learning network structure suitable for the user terminal 300 from among the scalable structures of the deep learning network and select at least one block corresponding to the decided deep learning network structure from among the plurality of blocks.

At operation 709, the electronic device 200 according to various embodiments may transmit the selected at least one block to the user terminal 300.

At operation 711, the user terminal 300 according to various embodiments may reconstruct the deep learning network, based on the received at least one block.

The user terminal 300 according to various embodiments may analyze data using the reconstructed deep learning network.

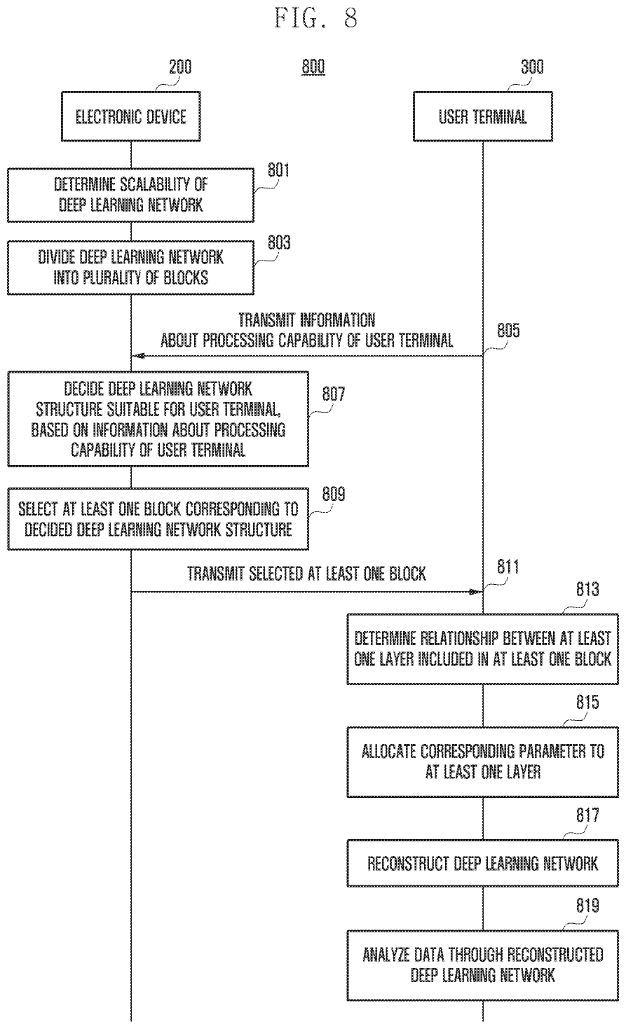

FIG. 8 is a flow diagram illustrating operations of an electronic device 200 according to an embodiment of the disclosure. Descriptions overlapping with those of FIG. 7 will be omitted.

Referring to FIG. 8, the flow diagram 800 of operations, the electronic device 200 according to various embodiments may determine the scalability of a deep learning network at operation 801. For example, based on the number of scalable structures of the deep learning network including a plurality of layers, the electronic device 200 may determine the scalability of the deep learning network.

At operation 803, the electronic device 200 according to various embodiments may divide the deep learning network into a plurality of blocks, based on the scalability.

At operation 805, the user terminal 300 according to various embodiments may transmit information about the processing capability of the user terminal 300 to the electronic device 200. The information about the processing capability of the user terminal 300 may include, for example, at least one of information about the operation processing capability of the user terminal 300 and a communication network speed.

At operation 807, the electronic device 200 according to various embodiments may decide a deep learning network structure suitable for the user terminal 300, based on the information about the processing capability of the user terminal 300. For example, based on the information about the processing capability of the user terminal 300, the electronic device 200 may decide a deep learning network structure most suitable for the user terminal 300 from among a plurality of scalable structures of the deep learning network.

At operation 809, the electronic device 200 according to various embodiments may select at least one block corresponding to the decided deep learning network structure.

At operation 811, the electronic device 200 according to various embodiments may transmit the selected at least one block to the user terminal 300. The selected at least one block may contain information about a deep learning network structure for each of the at least one block, a parameter corresponding to at least one layer included in each of the at least one block, and connection information between the at least one layer.

At operation 813, the user terminal 300 according to various embodiments may determine a relationship between the at least one layer included in the received at least one block. For example, based on the information about the deep learning network structure contained in the received at least one block, the user terminal 300 may determine a relationship between the at least one layer included in the received at least one block. For example, a stacking order of the at least one layer may be determined.

At operation 815, the user terminal 300 according to various embodiments may allocate a corresponding parameter to the at least one layer. For example, after determining the relationship between the at least one layer, the user terminal 300 may allocate a corresponding parameter to each of the at least one layer.

At operation 817, the user terminal 300 according to various embodiments may reconstruct the deep learning network. For example, based on the connection information between the at least one layer contained in the at least one block, the user terminal 300 may reconstruct the deep learning network. For example, the user terminal 300 may reconstruct the deep learning network corresponding to the deep learning network structure contained in the at least one block.

At operation 819, the user terminal 300 according to various embodiments may analyze data through the reconstructed deep learning network.

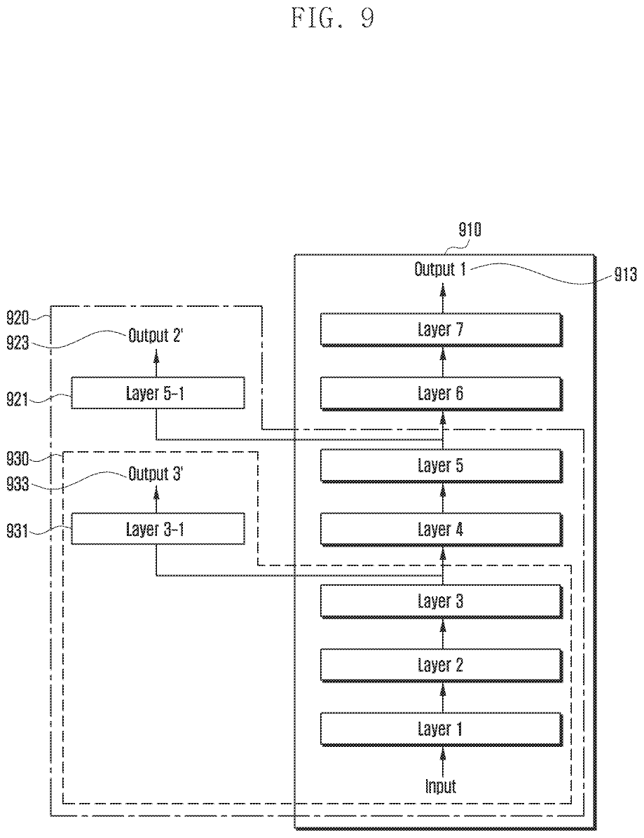

FIG. 9 is a diagram schematically illustrating a scalable deep learning network according to an embodiment of the disclosure. Descriptions overlapping with those of FIG. 4 will be omitted.

Referring to FIG. 9, the deep learning network according to various embodiments may have a plurality of scalable structures. FIG. 9 shows the deep learning network having three scalable structures. The number of scalable structures of the deep learning network may be defined as scalability. The deep learning network with scalability of 3 may be trained to output three output values.

The electronic device 200 according to various embodiments may add a specific layer to a specific deep learning network structure among the plurality of scalable structures of the deep learning network.

In case of a first deep learning network structure 910 capable of obtaining a first output value 913, it may generate the first output value 913 by going through all layers from the first layer to the seventh layer.

In case of a second deep learning network structure 920 capable of obtaining a second output value 923, it may generate the second output value 923 by going through the first to fifth layers and then additionally going through a fifth-first layer 921. According to various embodiments, in order to adjust the performance of the second output value 923 or generate the second output value 923 of a desired form, a specific layer may be added only to the second deep learning network structure 920. For example, when an output value obtained by going through the first to fifth layers does not reach a user's desired performance, the fifth-first layer 921 may be added after the fifth layer. The fifth-first layer 921 may be a layer included only in the second deep learning network structure 920.

In case of a third deep learning network structure 930 capable of obtaining a third output value 933, it may generate the third output value 933 by going through the first to third layers and then additionally going through a third-first layer 931. The third-first layer 931 may be a layer included only in the third deep learning network structure 930.

The electronic device 200 according to various embodiments may divide the deep learning network into a plurality of blocks including the added layer. For example, the first block may include the sixth layer and the seventh layer. The second block may include the fourth layer, the fifth layer, and the fifth-first layer 921. The third block may include the first layer, the second layer, the third layer, and the third-first layer 931.

In the above case, the second block may contain information about the second deep learning network structure 920. The second block may contain parameters corresponding to the fourth layer, the fifth layer, and the fifth-first 921.

In the above case, the third block may contain information about the third deep learning network structure 930. The third block may contain parameters corresponding to the first layer, the second layer, the third layer, and the third-first 931.

Although FIG. 9 shows an example in which one specific layer is added to a specific deep learning network structure, the number of added layers is not limited to one.

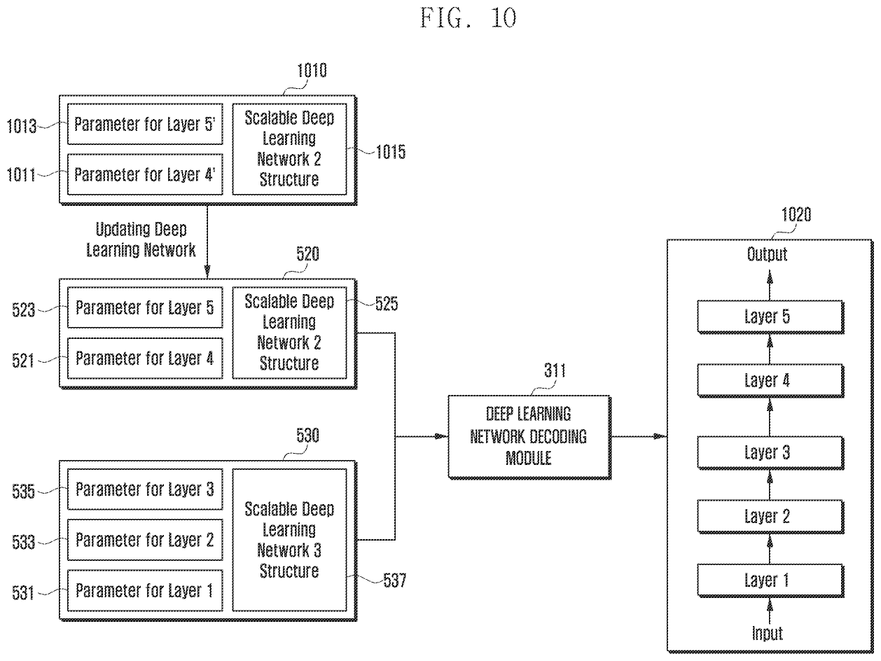

FIG. 10 is a diagram illustrating a method for updating a deep learning network in a user terminal according to an embodiment of the disclosure.

Referring to FIG. 10, the user terminal 300 according to various embodiments may reconstruct the deep learning network by using at least one block received from the electronic device 200. The user terminal 300 according to various embodiments may update the deep learning network by updating only a specific block among the received at least one block.

For example, suppose that the user terminal 300 received the second and third blocks 520 and 530 from the electronic device 200 and is using the deep learning network reconstructed to have the second deep learning network structure 420. If the update of the second block 520 is required, the user terminal 300 may request the update of the second block 520 from the electronic device 200. The user terminal 300 may receive an updated second block 1010 from the electronic device 200 and update the deep learning network. For example, the user terminal 300 may reconstruct a deep learning network 1020 by using the previously received third block 530 and the newly received updated second block 1010.

The updated second block 1010 may contain, for example, information about an updated second network structure 1015, a parameter 1011 corresponding to an updated fourth layer, and a parameter 1013 corresponding to an updated fifth layer.

The user terminal 300 according to various embodiments may reconstruct the deep learning network 1020 by receiving from the electronic device 200 only a specific block that needs to be updated among at least one block. The user terminal 300 does not receive the entire deep learning network from the electronic device 200 to update the deep learning network, but receives and updates only a specific block that needs to be updated, thereby reducing the update time and network data consumption.

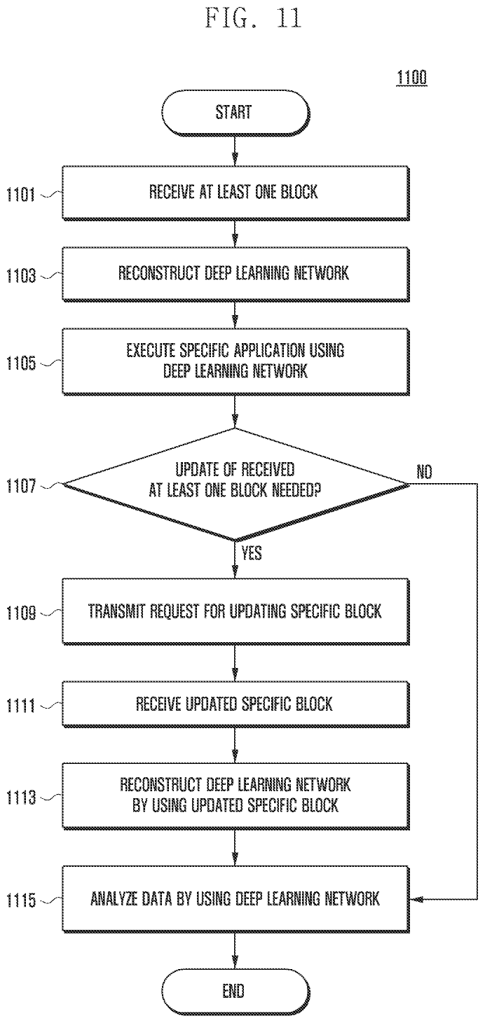

FIG. 11 is a flow diagram illustrating operations of a user terminal 300 according to an embodiment of the disclosure.

Referring to the flow diagram 1100 of operations, the user terminal 300 according to various embodiments may receive at least one block from the electronic device 200 at operation 1101.

At operation 1103, the user terminal 300 according to various embodiments may reconstruct the deep learning network by using the received at least one block.

At operation 1105, the user terminal 300 according to various embodiments may identify that a specific application using the deep learning network is executed. For example, the user terminal 300 may identify that a camera application using the deep learning network is executed.

At operation 1107, the user terminal 300 according to various embodiments may determine whether the received at least one block needs to be updated in response to the execution of the specific application that uses the deep learning network. For example, the user terminal 300 may check whether each of the received at least one block is the latest block.

If it is not necessary to update the received at least one block, the user terminal 300 may analyze data by using the reconstructed deep learning network at operation 1115. For example, when each of the received at least one block is the latest block, the user terminal 300 may determine that an update is not necessary, and use the previously reconstructed deep learning network.

If a specific block among the received at least one block needs to be updated, the user terminal 300 may transmit a request for updating the specific block to the electronic device 200 at operation 1109.

At operation 1111, the user terminal 300 according to various embodiments may receive an updated specific block from the electronic device 200 as a response to the update request.

At operation 1113, the user terminal 300 according to various embodiments may reconstruct the deep learning network by using the updated specific block. For example, using the updated specific block, the user terminal 300 may reconstruct the updated deep learning network.

At operation 1115, the user terminal 300 according to various embodiments may analyze data by using the reconstructed deep learning network.

According to various embodiments of the disclosure, an electronic device 200 may include a communication circuit 220, a processor 210, and a memory 230 operatively connected to the processor 210. The memory 230 according to various embodiments may store instructions that cause, when executed, the processor 210 to determine scalability of a deep learning network including a plurality of layers, to divide the deep learning network into a plurality of blocks, based on the scalability, to receive information about processing capability of a user terminal 300 from the user terminal 300, to select at least one of the plurality of blocks, based on the received information, and to transmit the selected at least one block to the user terminal 300.

In the electronic device 200 according to various embodiments of the disclosure, the instructions may cause the processor 210 to determine the scalability of the deep learning network, based on a number of scalable structures of the deep learning network.

In the electronic device 200 according to various embodiments of the disclosure, the information about the processing capability of the user terminal 300 may include at least one of information about operation processing capability of the user terminal 300 or a communication network speed.

In the electronic device 200 according to various embodiments of the disclosure, the instructions may cause the processor 210 to decide a deep learning network structure suitable for the user terminal 300 from among the scalable structures of the deep learning network, based on the received information, and to select at least one block corresponding to the decided deep learning network structure from among the plurality of blocks.

In the electronic device 200 according to various embodiments of the disclosure, the plurality of blocks may contain information about a deep learning network structure for each of the plurality of blocks, a parameter corresponding to at least one layer included in each of the plurality of blocks, and connection information between the at least one layer.

In the electronic device 200 according to various embodiments of the disclosure, the instructions may cause the processor 210 to train the deep learning network to output a number of result values corresponding to the determined scalability.

In the electronic device 200 according to various embodiments of the disclosure, the deep learning network may include at least one of a deep neural network (DNN), a convolutional neural network (CNN), a recurrent neural network (RNN), an auto encoder, a generative adversarial network (GAN), or a deep belief network (DBN).

In the electronic device 200 according to various embodiments of the disclosure, the instructions may cause the processor 210 to add a new layer to a specific block among the plurality of blocks, and the added new layer may be a layer not included in the plurality of layers.

In the electronic device 200 according to various embodiments of the disclosure, the instructions may cause the processor 210 to receive a request for updating a specific block from the user terminal 300, and to transmit, in response to the request, an updated specific block to the user terminal 300.

In the electronic device 200 according to various embodiments of the disclosure, the instructions may cause the processor 210 to generate a plurality of different blocks each including at least one layer among the plurality of layers, based on the scalability, and respective layers included in the plurality of blocks may overlap in part with each other.

According to various embodiments of the disclosure, a user terminal 300 may include a communication circuit 320, a processor 310, and a memory 330 operatively connected to the processor 310. The memory 330 according to various embodiments may store instructions that cause, when executed, the processor 310 to transmit information about processing capability of the user terminal 300 to an external electronic device 200, to receive at least one block including at least one of a plurality of layers of a deep learning network from the external electronic device 200, and to reconstruct a deep learning network by using the at least one block.

In the user terminal 300 according to various embodiments of the disclosure, the instructions may cause the processor 310 to analyze data through the reconstructed deep learning network.

In the user terminal 300 according to various embodiments of the disclosure, the at least one block may contain information about a deep learning network structure for each of the at least one block, a parameter corresponding to at least one layer included in each of the at least one block, and connection information between the at least one layer.

In the user terminal 300 according to various embodiments of the disclosure, the instructions may cause the processor 310 to determine a relationship between the at least one layer, based on the information about the deep learning network structure, to allocate a corresponding parameter to the at least one layer, and to reconstruct the deep learning network, based on the connection information between the at least one layer.

In the user terminal 300 according to various embodiments of the disclosure, the information about the processing capability of the user terminal 300 may include at least one of information about operation processing capability of the user terminal 300 or a communication network speed.

In the user terminal 300 according to various embodiments of the disclosure, the instructions may cause the processor 310 to, in response to a need to update a specific block among the at least one block, transmit a request for updating the specific block to the external electronic device 200, to receive an updated specific block from the external electronic device 200, and to reconstruct an updated deep learning network by using the updated specific block.

In the user terminal 300 according to various embodiments of the disclosure, the instructions may cause the processor 310 to, in response to execution of a specific application using the deep learning network, check whether an update of the at least one block is required.

According to various embodiments of the disclosure, a method for driving a deep learning network in an electronic device 200 may include operations of determining scalability of a deep learning network including a plurality of layers, dividing the deep learning network into a plurality of blocks, based on the scalability, receiving information about processing capability of a user terminal 300 from the user terminal 300, selecting at least one of the plurality of blocks, based on the received information, and transmitting the selected at least one block to the user terminal 300.

In the method for driving the deep learning network in the electronic device 200 according to various embodiments of the disclosure, the determining operation may be an operation of determining the scalability of the deep learning network, based on a number of scalable structures of the deep learning network.

In the method for driving the deep learning network in the electronic device 200 according to various embodiments of the disclosure, the information about the processing capability of the user terminal 300 may include at least one of information about operation processing capability of the user terminal 300 or a communication network speed.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuit;
a processor; and
a memory operatively connected to the processor,
wherein the memory stores instructions that cause, when executed, the processor to:
determine scalability of a deep learning network including a plurality of layers,
divide the deep learning network into a plurality of blocks, based on the scalability,
receive information about processing capability of a user terminal from the user terminal,
select at least one of the plurality of blocks, based on the received information, and
transmit the selected at least one block to the user terminal.

2. The electronic device of claim 1, wherein the instructions cause the processor to:
determine the scalability of the deep learning network, based on a number of scalable structures of the deep learning network.

3. The electronic device of claim 1, wherein the information about the processing capability of the user terminal includes at least one of information about operation processing capability of the user terminal or a communication network speed.

4. The electronic device of claim 1, wherein the instructions cause the processor to:
decide a deep learning network structure suitable for the user terminal from among the scalable structures of the deep learning network, based on the received information; and
select at least one block corresponding to the decided deep learning network structure from among the plurality of blocks.

5. The electronic device of claim 1, wherein the plurality of blocks contain information about a deep learning network structure for each of the plurality of blocks, a parameter corresponding to at least one layer included in each of the plurality of blocks, and connection information between the at least one layer.

6. The electronic device of claim 1, wherein the instructions cause the processor to:
train the deep learning network to output a number of result values corresponding to the determined scalability.

7. The electronic device of claim 1, wherein the deep learning network includes at least one of a deep neural network (DNN), a convolutional neural network (CNN), a recurrent neural network (RNN), an auto encoder, a generative adversarial network (GAN), or a deep belief network (DBN).

8. The electronic device of claim 1,
wherein the instructions cause the processor to:
add a new layer to a specific block among the plurality of blocks, and
wherein the added new layer is a layer not included in the plurality of layers.

9. The electronic device of claim 1, wherein the instructions cause the processor to:
receive a request for updating a specific block from the user terminal, and
transmit, in response to the request, an updated specific block to the user terminal.

10. The electronic device of claim 1,
wherein the instructions cause the processor to:
generate a plurality of different blocks each including at least one layer among the plurality of layers, based on the scalability, and
wherein respective layers included in the plurality of blocks overlap in part with each other.

11. A user terminal comprising:
a communication circuit;
a processor; and
a memory operatively connected to the processor,
wherein the memory stores instructions that cause, when executed, the processor to:
transmit information about processing capability of the user terminal to an external electronic device,
receive at least one block including at least one of a plurality of layers of a deep learning network from the external electronic device, and
reconstruct a deep learning network by using the at least one block.

12. The user terminal of claim 11, wherein the instructions cause the processor to:
analyze data through the reconstructed deep learning network.

13. The user terminal of claim 11, wherein the at least one block contains information about a deep learning network structure for each of the at least one block, a parameter corresponding to at least one layer included in each of the at least one block, and connection information between the at least one layer.

14. The user terminal of claim 11, wherein the information about the processing capability of the user terminal includes at least one of information about operation processing capability of the user terminal or a communication network speed.

15. The user terminal of claim 11, wherein the instructions cause the processor to:
in response to a need to update a specific block among the at least one block, transmit a request for updating the specific block to the external electronic device;
receive an updated specific block from the external electronic device; and
reconstruct an updated deep learning network by using the updated specific block.
